(19) United States
(12) Patent Application Publication
(10) Pub. No.: US 2004/0130117 A1
(43) Pub. Date: Jul. 8, 2004

(54) Collapsible bicycle case

(76) Inventor: Joshua Matthew Lipton, Flagstaff, AZ (US)

Correspondence Address: Joshua M. Lipton, 1919 Deer Crossing Rd., Flagstaff, AZ, 86004, US

(21) Appl. No.: 10/623,851

(22) Filed: Jul. 22, 2003

Related U.S. Application Data
(60) Provisional application No. 60/402,343, filed on Aug. 9, 2002.

(51) Int. Cl. B62K 27/00

(52) U.S. Cl. 280/204

(57) ABSTRACT

A lightweight bicycle transport case that has components which join to a central frame structure and then join together to form a complete bicycle case. The preferred embodiment and an additional embodiment of the central frame structure can be easily transported while riding a bicycle. The major components of the bicycle case consist of panel assemblies 34, a top cover 76, a front bracket 54, a rear bracket 56, and caster assemblies 60. The panel assemblies 34 each consist of four panels joined by hinges. The panel assemblies can be reconfigured from their open bicycle case position to their closed compact position which is easy to transport. The top cover 76 joins the opened panel assemblies 34 together into a complete bicycle case. The front bracket 54 and the rear bracket 56 provide an adjustable mounting interface between the central frame structure and the bicycle. Caster assemblies 60 provide the rolling mechanisms that allow for the bicycle case to be easily manually transported.

This application is based on U.S. Provisional Patent application No. 60/402,343 filed on Aug. 9, 2002.

### BACKGROUND—FIELD OF INVENTION

This invention relates to a bicycle transport case, specifically to a lightweight, transport case, which can be disassembled and folded down into a compact position for carrying while riding a bicycle.

### BACKGROUND—DESCRIPTION OF PRIOR ART

Travelers, including recreational and professional cyclists, often require or desire the shipment of a bicycle by air or ground to a travel destination for use at that destination. The bicycle is usually shipped in a hard-sided or soft-sided bicycle case. Among shipping cases, there are important differences in the amount of protection for the bicycle. These differences include the ease in which the bicycle is packed into the bicycle case, the ease of manually transporting the loaded bicycle case, the ease of carrying the bicycle case while riding a bicycle, and the storable size of the bicycle case when it is not in use.

Bicycle cases can be divided into the categories of collapsible and non-collapsible. The prior art demonstrates a variety of non-collapsible bicycle cases that adequately protect the bicycle from abuse during shipping. These bicycle cases are heavy and take up large amounts of storage space when not in use. They are not easily transported and often must be left behind at a central storage point to be reclaimed on a return trip. This presents a problem in finding a suitable place to store the container and limits the use of further public transportation at a later time during a bicycling tour.

The attempts at providing an easy way to transport a bicycle case while riding a bicycle are demonstrated in the prior art, by several bicycle cases that convert into accessories for the transportation of travel gear. These bicycle cases can be carried to other locations while riding the bicycle. They also have the benefit of providing a means to transport luggage. These examples are either overly complicated to use or do not work with full-sized bicycles.

Brenner, U.S. Pat. No. 4,390,088, discloses a bicycle case that reconfigures into a saddlebag. A disadvantage of Brenner is that the conversion from the bicycle case configuration to the saddlebag configuration is very complicated because it involves taking apart and reconfiguring multiple panels and straps. Another disadvantage is that luggage items must be unpacked into another bag when the saddlebags are reconfigured into a bicycle case.

The U.S. company, Bicycle Friday, demonstrates the use of a bicycle case for a folding bicycle. This bicycle case easily converts into a trailer. A disadvantage of the Bicycle Friday TavelCase is that it does not work with a regular-sized bicycle. Another disadvantage is that the trailer is a two-wheeled trailer, which unlike a single-wheeled trailer, is too wide to be pulled behind a bicycle on narrow trails.

Moench, German Pat. No. 97-551145/199751, discloses a trailer consisting of components, which can be rebuilt to form a bicycle case. A disadvantage of Moench is that the conversion from trailer to bicycle case is a complicated procedure, involving disassembling and reassembling the disconnecting parts of the frame structure. Another disadvantage is that the two-wheeled trailer does not have the performance benefits of a single-wheeled trailer.

The other collapsible bicycle cases in the prior art have the advantage over the prior art noncollapsible bicycle cases that they use up less storage space when not in use. All of the collapsible bicycle cases have the disadvantage of not providing an easy way to transport them while riding a bicycle. Specifically, Johnson, U.S. Pat. No. 4,756,416, discloses a light-weight flexible housing for removable, rigidifying panels. Another disadvantage of Johnson is that the panels do not have the structural-enhancing benefit of being connected by hinges or cross support members. Still an additional disadvantage is that it is complicated to use because each rigidifying panel must be inserted into its specific sleeve when setting it up for use.

Thompson, U.S. Pat. No. 3,871,546, discloses the use of hinged support panels that provide rigid protection and collapse with ease. This hinge structure has greater protective abilities than Johnson does, but Thompson still has the disadvantage that there is no rigid protection for the sides of the bicycle.

Lickton, U.S. Pat. No. 6,039,243, addresses the concern of rigid protection for all sides of the bicycle by disclosing the use of hinged support panels that completely enclose the case. Still the disadvantage of not providing a convenient means for transporting these cases while riding a bicycle is not addressed by Lickton.

Within the prior art for non-collapsible cases, there are several examples of useful methods of construction. Let it be noted that these features have not been previously implemented in collapsible cases. Williams, U.S. Pat. No. 4,991,715, and Dayton U.S. Pat. No. 4,792,039, both disclose a rigid, adjustable base for the vertical mounting of a bicycle frame by its front and rear dropouts. Delgado, U.S. Pat. No. 4,892,190, discloses an internal bicycle support system comprised of support bars that hold the bicycle in a centered position between the impact absorbing sides of the case. Profeta, U.S. Pat. No. 4,378,883, discloses a bicycle case that is shaped to closely fit the contour of a disassembled bicycle and uses up less storage and shipping space.

A need, therefore, has arisen for a collapsible bicycle case that is quick and easy to assemble and disassemble, works with full-size bicycles, is easy to transport while riding a bicycle, is easy to transport manually when loaded, takes up little storage space when not in use, and offers complete protection against the abusiveness of cargo handling.

### OBJECTS AND ADVANTAGES

Accordingly, several objects and advantages of the present invention are:

(a) to provide a collapsible bicycle case that is quick and easy to assemble and disassemble.

(b) to provide a collapsible bicycle case that is lightweight and can be easily transported by a cyclist while riding a bicycle. It is difficult to obtain bicycle cases and to conveniently store them when traveling. This bicycle case solves both of these problems by providing a means to transport it while traveling by bicycle.

(c) to provide a collapsible bicycle case that offers complete protection for a bicycle against the abusiveness of cargo handling.

(d) to provide a collapsible bicycle case with devises for holding the bicycle in a centered position between the case's protective panels, so that the bicycle does not come into contact with the panels as they are absorbing the abuses of cargo handling.

(e) to provide a collapsible bicycle case that is easy to transport manually when loaded.

(f) to provide a collapsible bicycle case that takes up a minimal amount of storage space when not in use.

(g) to provide a collapsible bicycle case that has adjustable brackets for mounting a bicycle's front and rear dropouts, accommodating a variety of bicycle sizes.

(h) to provide a collapsible bicycle case that fits a full-sized, disassembled, adult bicycle.

(i) to provide a collapsible bicycle case that is contoured around the shape of a disassembled bicycle in order to save space in shipping and comply with shipping standards.

(j) to provide a collapsible bicycle case that is cost effective to produce.

(k) to provide a collapsible bicycle case with an embodiment that can utilize the frame structure of a bicycle trailer without impairing the normal use of the bicycle trailer. The bicycle trailer can be used for transporting travel gear after it has assisted in transporting the bicycle to the point of departure of a bicycle tour. The particular trailer used in the preferred embodiment has multiple design benefits including its single-wheeled design that allows for the trailer to be pulled behind a bicycle on narrow trails.

(l) to provide a collapsible bicycle case with a preferred embodiment that contains components that can easily assemble and disassemble onto a bicycle trailer, allowing for easy initial setup and for easy removal when it is desired to use the trailer without the added weight of the bicycle case components.

(m) to provide a collapsible bicycle case with a preferred embodiment that enables cost efficiency for the users of a bicycle trailer by allowing them to gain a secondary purpose for their bicycle trailer.

(n) to provide a collapsible bicycle case with an additional embodiment that mounts onto a collapsible bicycle case frame. The components of the bicycle case and the collapsible bicycle frame can be folded up and collapsed into a position that can be mounted to the seat post of a bicycle and easily transported while riding the bicycle.

Further objects and advantages will become apparent from a consideration of the ensuing description and drawings.

### SUMMARY

A lightweight bicycle transport case, which is mounted to and utilizes a central frame structure as a base support and can be disassembled and folded down onto the central frame structure for ease of transport while riding the bicycle. This central frame structure is either a collapsible structure that can be mounted to the bicycle or a bicycle trailer that can be towed behind the bicycle. When the bicycle trailer is used as the central frame structure, it can also be used to transport travel gear during bicycle travel.

### DRAWINGS

### Drawing Figures

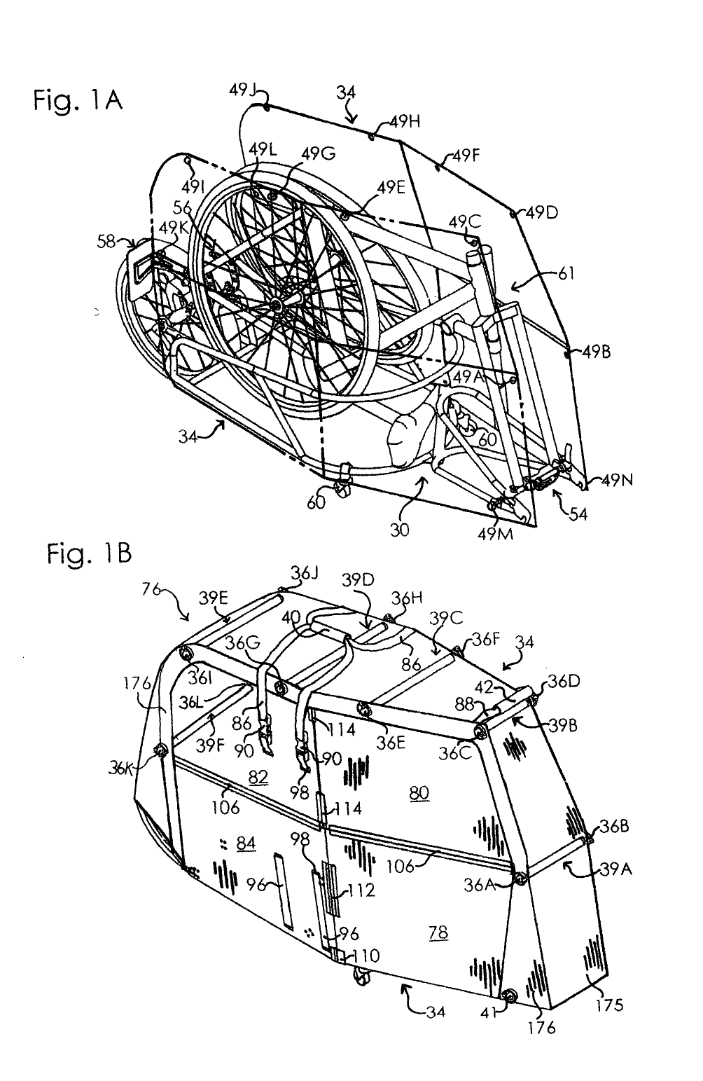

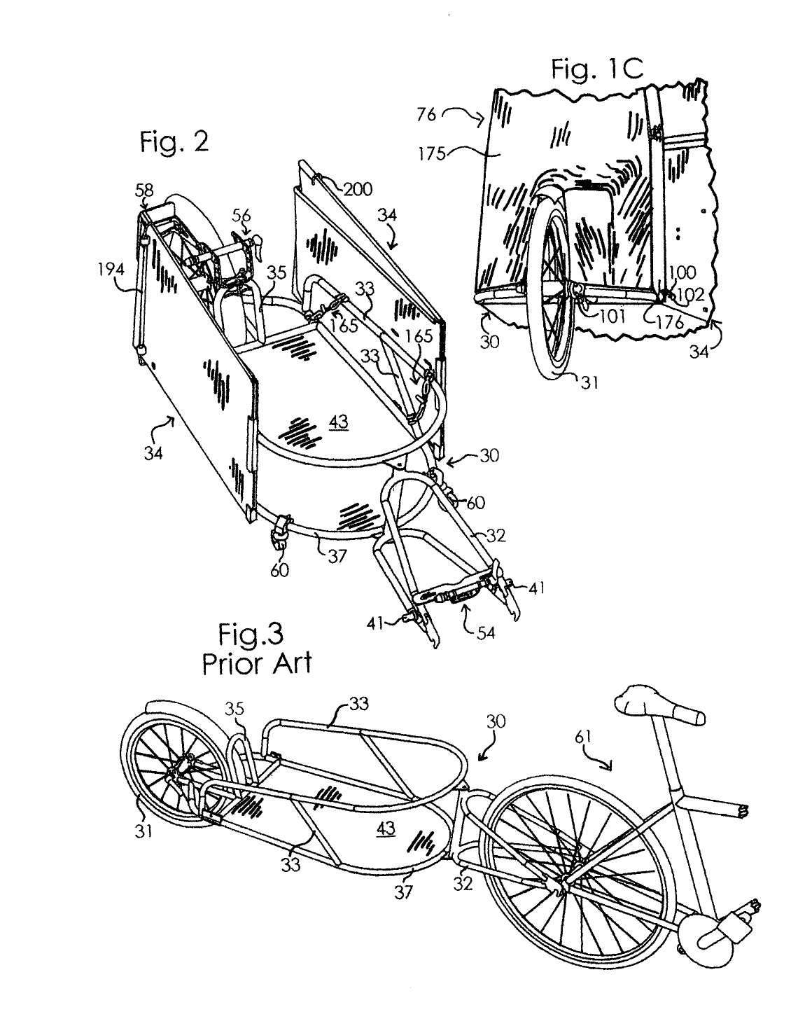

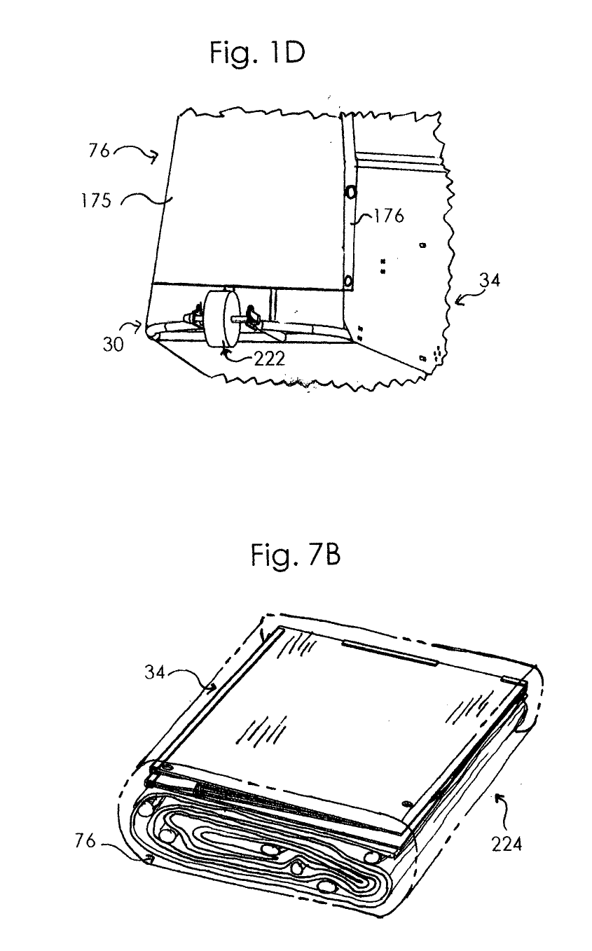

FIG. 1A shows a see-through view of the panel assemblies;

FIG. 1B shows an external view of the collapsible bicycle case. The crossbars assemblies, which would not normally be visible, are depicted to show their positioning in relation to the panel assemblies;

FIG. 1C shows an external view of the rear end of the collapsible bicycle case;

FIG. 1D shows an additional external view of the rear end of the collapsible bicycle case;

FIG. 2 shows a bicycle trailer with folded-down side panels mounted to it;

FIG. 3 shows a bicycle trailer mounted to a bicycle;

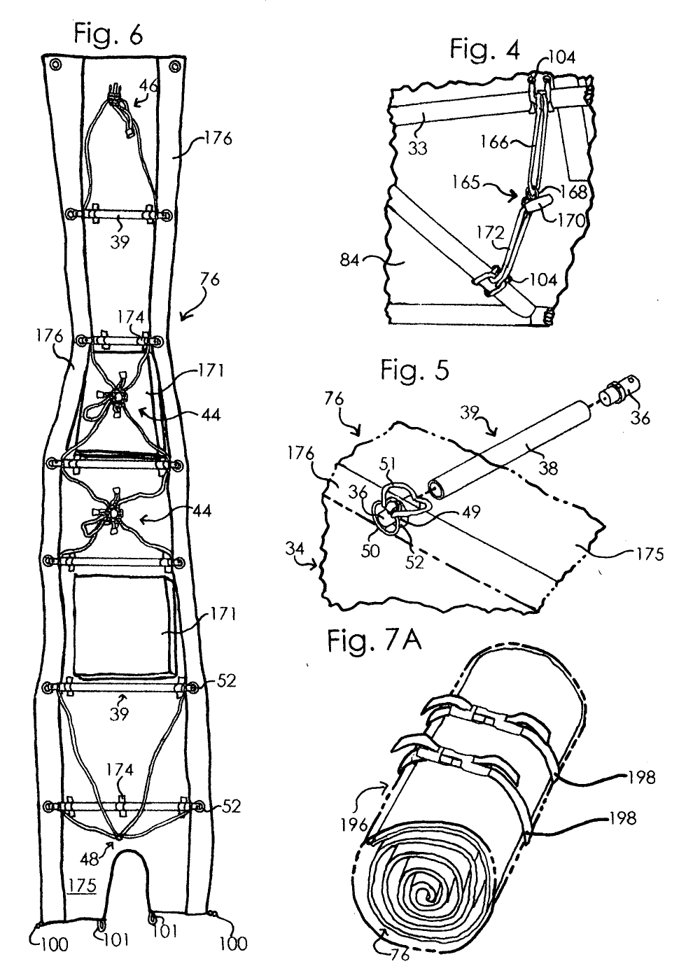

FIG. 4 shows a panel cinch;

FIG. 5 shows an exploded view of a crossbar assembly. A section of a panel assembly and a see through section of the top cover are depicted to show the relative position of the crossbar assembly;

FIG. 6 shows the underside of the top cover in an unrolled position;

FIG. 7A shows the top cover in a rolled up position. It is shown inside of a see through view of a handlebar bag;

FIG. 7B shows the top cover and the panel assemblies inside of a see through view of the shipping/storage bag

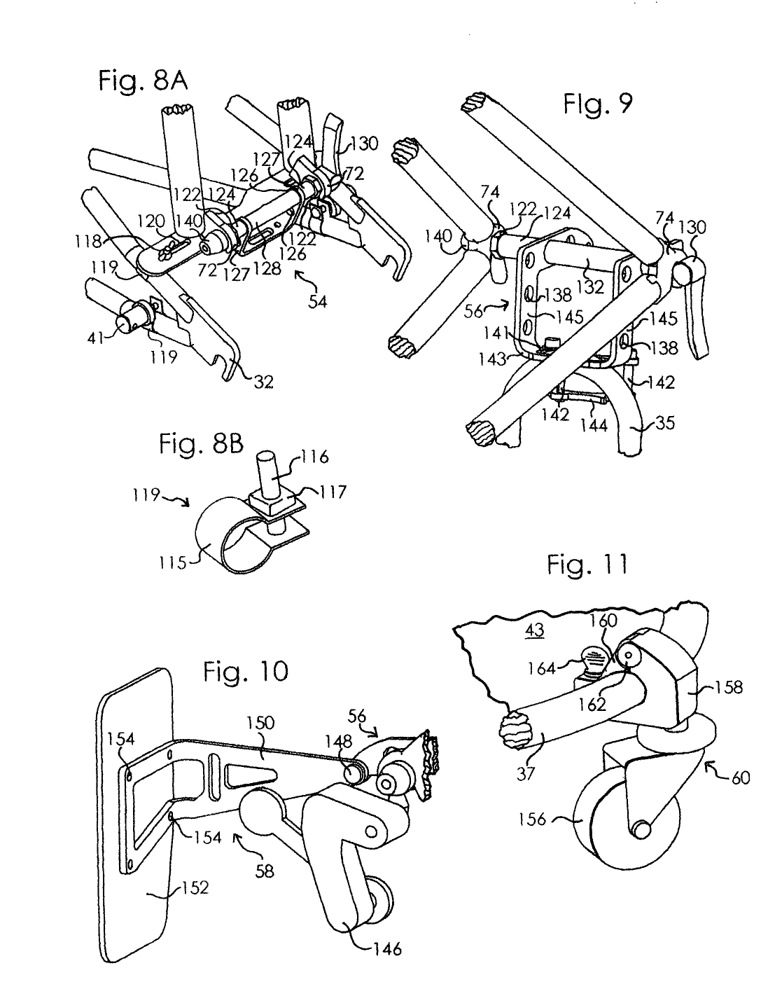

FIG. 8A shows the front bracket and the trailer fork caps;

FIG. 8B shows the trailer fork mounting assemblies;

FIG. 9 shows the rear bracket;

FIG. 10 shows the derailleur guard;

FIG. 11 shows the caster assembly;

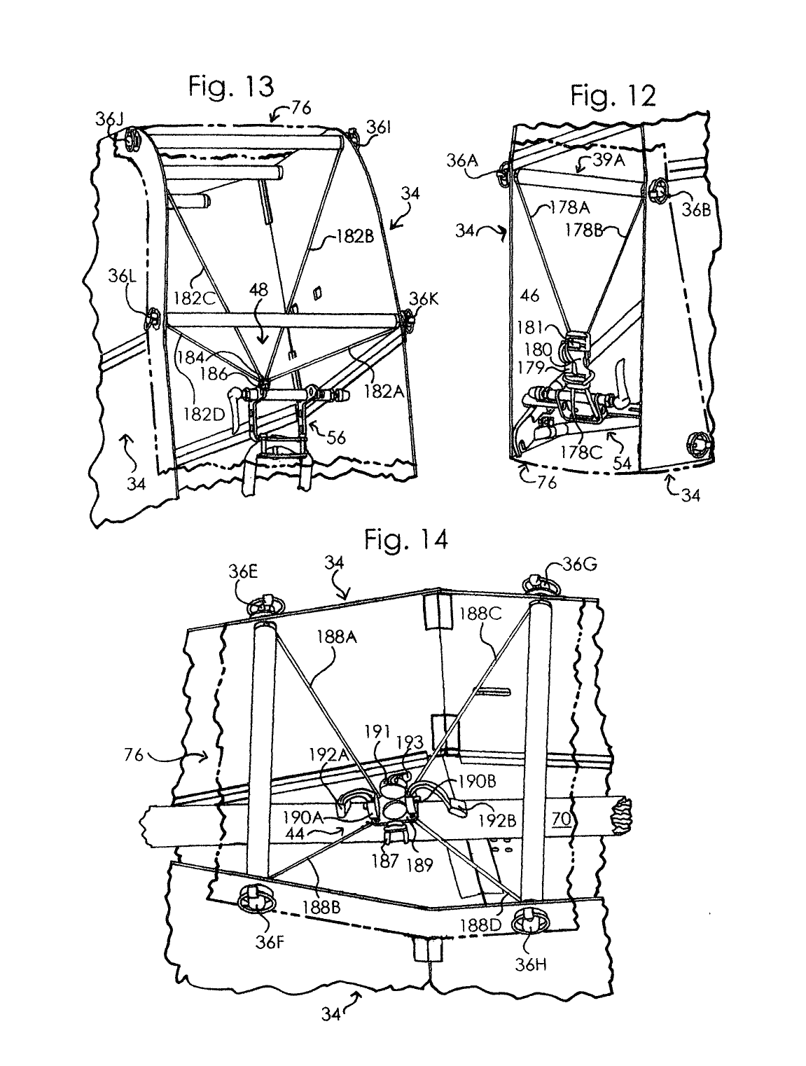

FIG. 12 shows the front tensioner;

FIG. 13 shows the rear tensioner;

FIG. 14 shows the rearward-most of the two frame tensioners;

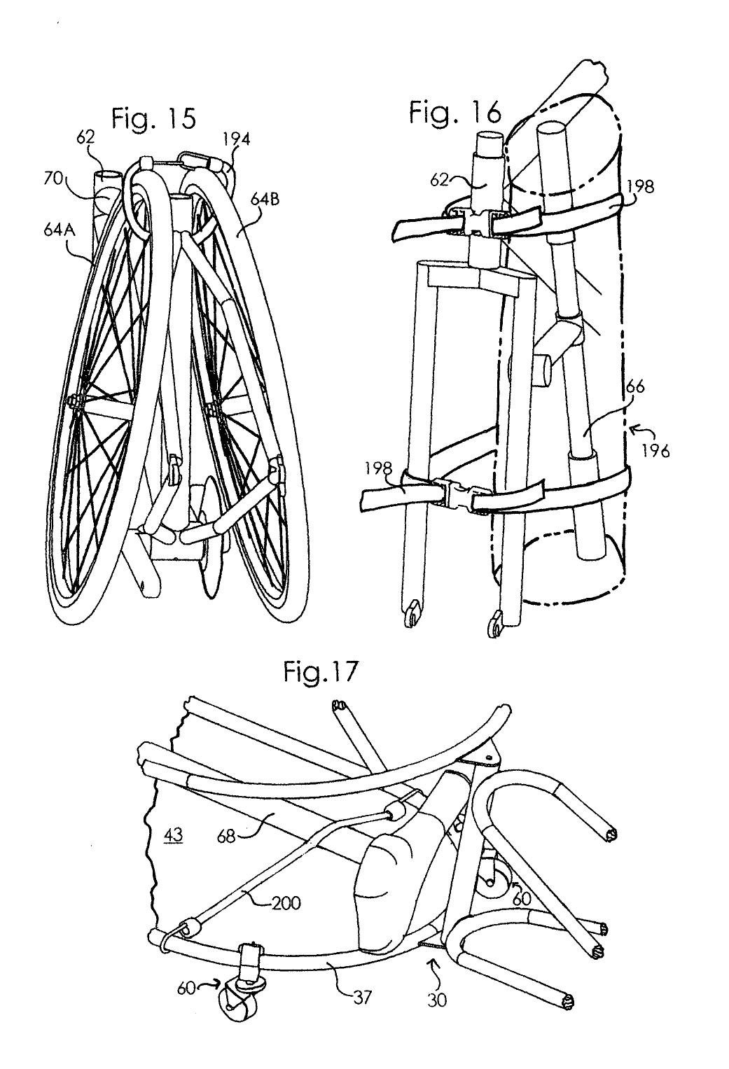

FIG. 15 shows the placement of the two bicycle wheels in relation to the bicycle frame when it is mounted in the bicycle case for shipping;

FIG. 16 shows the placement of the handlebars against the bicycle frame when it is mounted in the bicycle case for shipping. The handlebars are shown in the see through handlebar bag;

FIG. 17 shows the placement of the seat post on the bottom of the trailer for shipping;

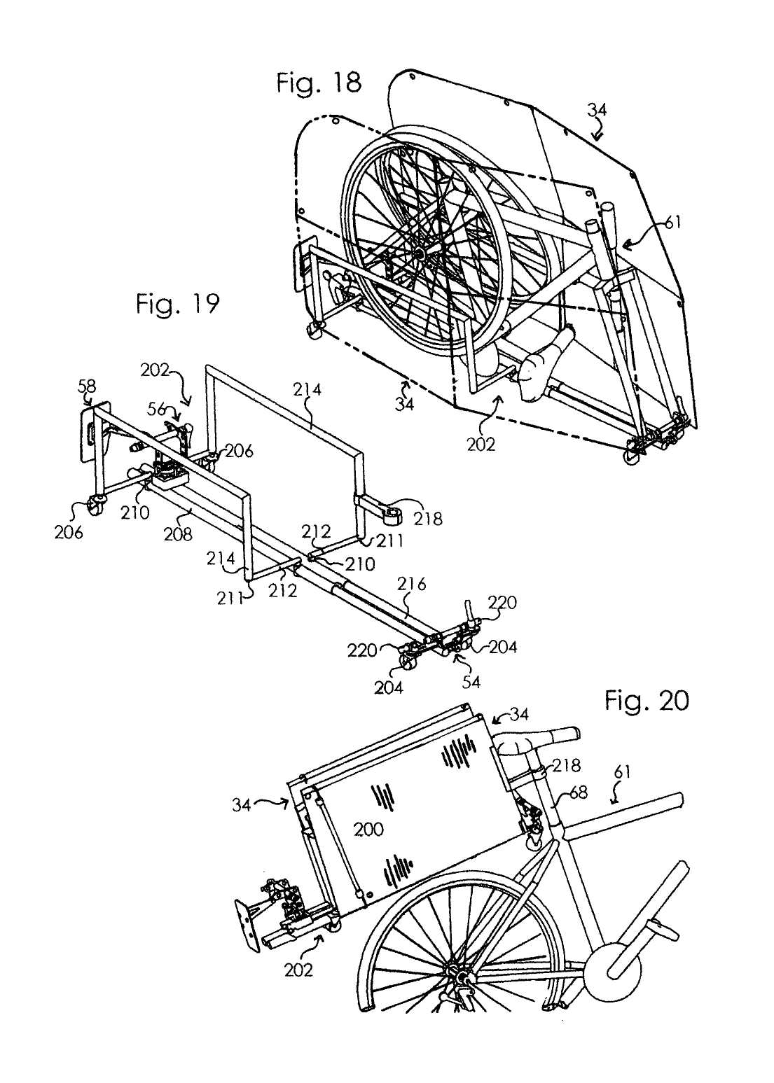

FIG. 18 shows a see-through view of the panel assemblies mounted to the collapsible frame;

FIG. 19 shows the collapsible frame in its open position without the side panels mounted,

FIG. 20 shows the collapsible frame in its collapsed position with side panels mounted in their folded position. The bicycle case is shown mounted on the seat post of a bicycle.

### REFERENCE NUMERALS IN DRAWINGS

30 trailer

31 trailer wheel

32 trailer fork

33 trailer sides

34 panel assemblies

35 luggage stop

36 crossbar caps

37 trailer bottom tube

38 crossbars

39 crossbar assemblies

40 center handle

41 trailer fork caps

42 front handle

43 trailer bottom mesh

44 frame tensioners

46 front tensioner

48 rear tensioner

49 panel holes

50 lich pins

51 linch pin loops

52 grommets

54 front bracket

56 rear bracket

58 derailleur guard

60 caster assemblies

61 bicycle

62 bicycle frame

64 bicycle wheels

66 handlebar

68 seat post

70 top tube

72 front dropouts

74 rear dropouts

76 top cover

78 bottom front panels

80 top front panels

82 top rear panels

84 bottom rear panels

86 center handle straps

88 front handle strap

90 cover buckles

96 support straps

98 strap slots

100 cover hooks

101 cover loops

102 panel rings

104 cinch hole patterns

106 horizontal hinges

110 bottom spread hinges

112 top spread hinges

114 vertical hinges

115 trailer fork clamps

116 trailer fork screws

117 trailer fork nuts

118 wing nuts

119 trailer fork mounting assemblies

120 front bracket slots

122 axle nuts

124 axle spacers

126 front axle positions

127 front bracket tabs

128 front axle

130 quick releases

132 rear axle

138 rear axle positions

140 quick release nuts

141 rear bracket gap

142 rear clamp screws

143 rear bracket top piece

144 rear bracket clamp

145 rear bracket tabs

146 derailleur

148 guard mount screw

150 guard bracket

152 guard plate

154 guard plate screws

156 casters

158 caster brackets

160 caster bracket hinges

162 sex bolts

164 thumb screws

165 panel cinches

166 elastic cinches

168 cinch hooks

170 cinch cord closures

171 pads

172 cord cinches

174 crossbar sleeves

175 center panel

176 top cover skirts

178 front tensioner cords

179 front tensioner cord stop

180 front tensioner buckle

181 front tensioner cord lock

182 rear tensioner cords

184 rear tensioner ring

186 rear bracket hook

187 frame tensioner loops

188 frame tensioner cords

189 frame tensioner guides

190 frame tensioner cord locks

191 frame tensioner loop locks

192 frame tensioner cord stops

193 frame tensioner loop stops

194 bicycle wheel elastic

196 handlebar bag

198 compression straps

200 seat post elastic

202 collapsible frame

204 collapsible frame front casters

206 collapsible frame rear casters

208 mounting body

210 swivel arm joints

211 panel support joints

212 swivel arms

214 panel supports

216 extendable arm

218 seat post mount

220 collapsible frame panel mounts

222 small wheel

224 shipping/storage bag

### DETAILED DESCRIPTION

Description—FIGS. 1-18—Preferred Embodiment

A preferred embodiment of the bicycle case of the present invention is illustrated with an internal view in FIG. 1A. All of the parts of a disassembled bicycle 61 are visible. A trailer 30 and most of the bicycle case components are also visible. Only the major outlines of the panel assemblies 34 are visible to show their position relative to the bicycle and the other collapsible case components. An external view is illustrated in FIG. 1B and a rear external view is illustrated in FIG. 1C. A second rear external view is illustrated in FIG. 1D. The bicycle case is comprised of the following components: panel assemblies 34, a front bracket 54, a rear bracket 56, a derailleur guard 58, caster assemblies 60, and a top cover 76. These bicycle case components are mounted to and utilize the structure of a bicycle trailer 30. A disassembled bicycle 61 is mounted to the front bracket 54 and the rear bracket 56 inside of the bicycle case.

FIG. 2 depicts the panel assemblies 34 in their folded positions, mounted to the trailer 30. FIG. 3 is a view of the trailer 30 mounted behind a bicycle 61 to illustrate the appearance of the trailer 30 before the bicycle case parts are mounted to it. The bicycle trailer 30 makes up the central frame structure for the assembly of the component parts of the bicycle case. The front bracket 54 and the trailer fork caps 41 mount to the trailer fork 32. The rear bracket 56 mounts to the luggage stop 35. The caster assemblies 60 mount to the trailer bottom tube 37 and the trailer bottom mesh 43. Panel assemblies 34 mount to the trailer sides 33.

FIG. 4 depicts one of the four panel cinches 165 on the inside facing surface of one of the bottom rear panels 84. The panel cinches 165 are used to mount the panel assemblies 34 to the trailer sides 33. The elastic cinches 166 and the cord cinches 172 are laced through the cinch holes patterns 104 and around the trailer sides 33. The cord cinches 172 are attached to the cinch cord closures 170. The elastic cinches 166 are attached to the cinch hooks 168. The cinch hooks 168 are hooked around the cinch cord closures 170, fixing the panel cinches 165 in position.

FIG. 1B depicts an external view of the collapsible bicycle case with the panel assemblies 34 in their open position. The panel assemblies 34 are comprised of rigid panels preferably made from an impact resistant plastic such as ABS. The panel assemblies 34 can be made lighter without a significant reduction of strength and rigidity by removing circular cutouts in a patterned removal throughout the surface of the panel assemblies 34. The panel assemblies 34 are connected with hinges preferably made from a flexible plastic. The bottom rear panels 84 are mounted to the trailer sides 33. The top rear panels 82 are located above the bottom rear panels 84 with horizontal hinges 106 fixed between them. The bottom front panels 78 are located in front of the bottom rear panels 84 with bottom spread hinges 110 and top spread hinges 112 fixed between them. The top front panels 80 are located above the bottom front panels 78 with the horizontal hinges 106 fixed between them. Fixed between the top front panels 80 and the top rear panels 82 are the vertical hinges 114.

FIG. 6 depicts the underside of the top cover 76. The top cover 76 is constructed from a flexible, pliable material, preferably pack cloth. The top cover 76 is comprised of a center panel 175, top cover skirts 176, crossbar assemblies 39, crossbar sleeves 174, grommets 52, linch pins 50, linch pin loops 51, a front tensioner 46, a rear tensioner 48, frame tensioners 44, pads 171, center handle straps 86, a center handle 40, a front handle strap 88, and a front handle 42. The crossbar assemblies 39 are fixed to the center panel 175 by the crossbar sleeves 174. The cords of the front tensioner 46, the rear tensioner 48, and the frame tensioner 44 are laced through each of their adjacent crossbar caps 36, further fixing the crossbar assemblies 39 to the top cover 76. The pads 171 are sewn into the center panel 175. Grommets 52 are located on the top cover skirts 176 positioned on both sides of every crossbar assembly 39 and also on both sides of the front edge of the top cover skirt 176.

FIG. 5 depicts an exploded view of one of the six crossbar assemblies 39 comprised of a crossbar 38 and two crossbar caps 36. The crossbar cap 36 is inserted through the panel hole 49 and the grommet 52. The linch pin 50 is inserted through the end of the crossbar cap 36, fixing it in position. Linch pin loops 51 are sewn into the top cover 76 close to the location of each grommet 52. The linch pin loops 51 are attached to the linch pins 50.

FIG. 1B depicts the external details of the top cover 76. The top cover 76 is secured along the perimeter of the panel assemblies 34 by mounting the crossbar assemblies 39 in their relative positions to the adjacent grommet 52 and panel hole 49 as described above. The front end of the top cover 76 is secured in place with the grommets 52 that fit over the trailer fork caps 41 and are secured in place with linch pins 50. The trailer fork caps 41 are explained in detail, further on in these specifications. The support straps 96 lace through the support strap slots 98 and through the bottom slots of the cover buckles 90. The two center handle straps 86 are sewn into the top cover skirt 176 and lace through the top slots of the cover buckles 90. Both center handle straps 86 meet at the center handle 40, lacing though its openings. The front handle strap 88 laces through the openings in the front handle 42 and is sewn into the top cover 76.

FIG. 1C shows an external view of the rear end of the top cover 76. The outside comers of the rear end of the top cover 76 are secured in place with cover hooks 100 that hook to the panel rings 102. The center section of the rear end of the top cover 76 is secured with cover loops 101 that fit over the trailer 30. The trailer wheel 31 remains installed to the trailer 30.

FIG. 1D shows a second view of the rear end of the top cover 76. Additional crossbar assemblies 39 have been added to this area of the top cover 76 to protect the derailleur 146. The derailleur guard 58 is not used. A small wheel 222 replaces the trailer wheel 31.

FIG. 7A shows the top cover 76 rolled up and stored inside a handlebar bag 196 for easy transport when not in use. FIG. 7B shows the top cover 76 and the panel assemblies 34 stored inside of the storage/shipping bag 224.

FIG. 8B depicts one of the four trailer fork mounting assemblies 119. The trailer fork clamp 115 fits around the trailer fork 32. The trailer fork screw 116 inserts through the trailer fork clamp 115 and threads into the trailer fork nut 117, securing it in position on the trailer fork 32.

FIG. 8A depicts the front bracket 54. Two of the trailer fork mounting assemblies 119 are positioned for mounting to the front bracket 54. The positioning slots 120 of the front bracket 54 fit over the trailer fork screws 116 of the trailer fork mounting assemblies 119. The wing nuts 118 thread onto the trailer fork screws 116, securing the front bracket 54 in place. The front bracket 54 is preferably a profile cut from aluminum and formed with two front bracket tabs 127 bent at right angles. The front bracket tabs 127 have two axle positions 126 for a front axle 128 to be inserted through. Axle spacers 124 fit over the front axle 128. Two axle nuts 122 thread onto the front axle 128, fixing the axle spacers 124 in position on the front bracket 54. The front dropouts 72 of the bicycle 61 fit over the front axle 128. A quick release 130 inserts through the front axle 128 and threads into a quick release nut 140, securing the front dropouts 72 to the front axle 128.

FIG. 8A also depicts the trailer fork caps 41. Two trailer fork mounting assemblies 119 are positioned on the trailer fork 32 for attaching to the trailer fork caps 41. The trailer fork caps 41 thread onto the trailer fork screws 116.

FIG. 9 depicts the rear bracket 56. Rear clamp screws 142 insert through a rear bracket top piece 143 and thread into a rear bracket clamp 144, mounting the rear bracket 56 to the luggage stop 35. The rear bracket top piece 143 is preferably a profile cut from aluminum with two rear bracket tabs 145 bent at right angles. The rear bracket tabs have five rear axle positions 138 for a rear axle 132 to be inserted through. Axle spacers 124 fit over the rear axle 132. Two axle nuts 122 thread on the rear axle 132 fixing the axle spacers 124 into position on the rear bracket 56. The rear dropouts 74 of the bicycle 61 fit over the rear axle 132. A quick release 130 inserts through the rear axle 132 and threads into a quick release nut 140, securing the rear dropouts 74 to the rear axle 132.

FIG. 10 depicts the derailleur guard 58. When the disassembled bicycle 61 is mounted in the bicycle case, the derailleur 146 is located in close proximity to the derailleur guard 58. A guard mount screw 148 inserts through a guard bracket 150 and threads into the rear bracket 56. Guard plate screws 154 insert through a guard plate 152 and thread into the guard bracket 150.

FIG. 11 depicts one of two caster assemblies 60. The caster brackets 158 and the caster bracket hinges 160 are preferably cut or cast out of aluminum. The caster brackets 158 fit over the trailer bottom tube 37. The sex bolts 162 are inserted through the caster brackets 158 and the caster bracket hinges 160, joining them together. The thumb screws 164 insert through the caster bracket hinges 160 and the trailer bottom mesh 43 and then thread into the caster brackets 158, securing them in place. The casters 156 thread into the caster brackets 158.

FIG. 12 depicts the front tensioner 46. Front tensioner cords 178A and 178B are laced through crossbar caps 36A and 36B and through the slots of the front tensioner buckle 180. The front tensioner cords 178A and 178B are then laced through the front tensioner cord lock 181 and into the front tensioner cord stop 179. Front tensioner cord 178C is laced through front bracket 54 and tied into slots on the front tensioner buckle 180.

FIG. 13 depicts the rear tensioner 48. Rear tensioner cords 182A, 182B, 182C, and 182D are laced through crossbar caps 36K, 361, 36J, and 36L, and converge at a rear tensioner ring 184, which they are tied to. The rear bracket hook 186 hooks to the rear tensioner ring 184, fixing it in place.

FIG. 14 depicts the rearward of the two frame tensioners 44. Frame tensioner cords 188A, 188B, 188C, and 188D are laced through the crossbar caps 36E, 36F, 36G, and 36H and then laced through the frame tensioner guide 189. The frame tensioner cords 188A and 188B are laced through the frame tensioner cord lock 190A and into the frame tensioner cord stop 192A. The frame tensioner cords 188C and 188D are laced through the frame tensioner cord lock 190B and into the frame tensioner cord stop 192B. The frame tensioner loop 187 laces around the top tube 70, through the frame tensioner guide 189, through the frame tensioner loop lock 191, and into the frame tensioner loop stop 193. The frame tensioner loop 187 fits over the end of the fame tensioner guide 189, fixing it against the top tube 70. The forward most frame tensioner 44 is constructed in the same way as the forward most frame tensioner 44 and utilizes the crossbar caps 36C, 36D, 36E, and 36F. It mounts to the front section of the top tube 70.

FIG. 15 depicts the placement of the bicycle wheels 64 in relation to the bicycle frame 62. The bicycle wheel elastic 194 wraps around the bicycle wheels 64 and through the bicycle frame 62. FIG. 16 shows a see-through view of the placement of the handlebars 66 in the handlebar bag 196 in relation to the bicycle frame 62. The shipping/storage bag 224 shown in FIG. 7A can also be used for this same purpose. Compression straps 198 are sewn to the handlebar bag 196. The compression straps 198 wrap around the bicycle frame 62, mounting the handlebar bag 196 in position. FIG. 17 shows the placement of the seat post 68 on the trailer bottom mesh 43. The seat post elastic 200 inserts through the bicycle seat 68 and hooks to the trailer bottom tube 37 in two sections, securing it in place.

Operation—FIGS. 1-17—Preferred Embodiment

The description of the operation of the bicycle case can be divided into the following four parts: a description of how the components are mounted to the trailer 30, a description of how the disassembled bicycle 61 is mounted inside of the bicycle case, a description of how the components protect the disassembled bicycle 61, and a description of how the bicycle case is handled manually with the disassembled bicycle 61 mounted inside of it.

FIG. 3 shows the trailer 30 before the bicycle case components are mounted onto it. FIG. 2 shows the trailer 30 after the bicycle case components have been mounted onto it. The panel assemblies 34 are mounted to the trailer 30 with the panel cinches 165. FIG. 4 shows a close-up of one of the four panel cinches 165. The elastic cinches 166 are laced through their own looped section and cinched around the trailer sides 33. The cord cinches 172 are also laced through their own looped section and cinched around the trailer sides 33. The cinch hooks 168 on the end of the elastic cinches 166 are stretched towards and hooked onto the cinch cord closures 170 on the end of the cord cinches 172. The four panel cinches 165, on the inside facing surfaces of the two bottom rear panels 84, are hooked around the trailer sides 33 to mount the panel assemblies 34 in position.

FIGS. 8A and 8B depict the trailer fork mounting assemblies 119. To install the trailer fork mounting assembly 119, the trailer fork clamps 115 are bent open and then closed around the tubing of the trailer fork 32. The trailer fork screws 116 are inserted through the trailer fork clamps 115, threaded into the trailer fork nuts 117, and tightened in the correct position. The positions of the trailer fork mounting assemblies 119 that are used for the trailer fork caps 41 are towards the front end of the trailer fork 32. These relative positions are shown in FIG. 8A. The trailer fork caps 41 are threaded onto the trailer fork screws 116.

The position of the trailer fork mounting assemblies 119 for the front bracket 54 is dependent upon where the front bracket 54 needs to be placed along the trailer fork 32 for interfacing with the front dropouts 72 of the bicycle 61. The distance that the front dropouts 72 extend over the trailer fork 32 is based upon the variable distance between the front dropouts 72 and the rear dropouts 74. Once the necessary position is determined, the trailer fork mounting assemblies 119 are installed. The front bracket 54 is mounted to the trailer fork mounting assemblies 119, by inserting the trailer fork screws 116 through the front bracket slots 120. The thumb screws 118 thread onto the trailer fork screws 116, fixing the front bracket 54 in position. The front bracket 54 can be further adjusted by removing the axle nuts 122 and the axle spacers 124 and reinstalling the front axle 128 in the other front axle position 126. The front bracket 54 must be removed from the trailer fork 32 when the trailer 30 is attached behind the bicycle 61 as depicted in FIG. 3.

FIG. 9 depicts the rear bracket 56 mounted to the luggage stop 35. The luggage stop 35 fits into the rear bracket gap 141. Three rear clamp screws 142 insert through the rear bracket top piece 143 and thread into the rear bracket clamp 144. The rear clamps screws 142 are tightened to clamp the rear bracket 56 onto the luggage stop 35. The rear axle 132 can be positioned on any of the five rear axle positions 138 by removing the axle nuts 122 and the axle spacers 124 and reinstalling them on the rear axle 132 in the chosen position. The positioning of the rear axle 132 is determined by the relative positioning of the front bracket 54 and the overall fit of the bicycle frame 62 within the bicycle case.

FIG. 10 depicts the derailleur guard 58 mounted to the rear bracket 56. Installation of the derailleur guard 58 involves inserting a guard mount screw 148 through the guard bracket 150 and threading it into the rear bracket 56. When the disassembled bicycle 61 is loaded into the bicycle case, the derailleur 146 is positioned so that it is protected by the structure of the derailleur guard 58.

FIG. 11 depicts one of the two caster assemblies 60 mounted to the trailer bottom tube 37. When the caster assemblies 60 are installed, the caster brackets 158 rest on the underside of the trailer bottom tube 37 and the underside of the trailer bottom mesh 43. The sex bolts 162 function as hinge pins between the caster brackets 158 and the caster bracket hinges 160. The caster bracket hinges 160 swing up to allow the caster assemblies 60 to fit over the trailer bottom tube 37. The caster bracket hinges 160 then swing down over the trailer bottom tube 37 for mounting. The caster bracket hinges 160 rest against the top side of the trailer bottom mesh 43. The thumb screws 164 insert through the caster bracket hinges 160, through the trailer bottom mesh 43, and thread into the caster brackets 158, fixing the caster assemblies 60 in position. The relative position of the caster assemblies 60 along the trailer bottom tube 37 is shown in FIG. 2.

FIG. 1C depicts the trailer wheel 3 1eft installed for use with the collapsible bicycle case. The small wheel 222 depicted in FIG. 1D can be used to replace the trailer wheel 31. The trailer wheel 31 is removed from the trailer 30 and stored inside of the collapsible bicycle case. The small wheel 222 is then installed onto the trailer 30.

Once the bicycle case components have been installed onto the trailer 30, it is ready to use as a bicycle case. The bicycle wheels 64 are first removed from the bicycle 61. The bicycle frame 62 is then mounted to the front bracket 54 and the rear bracket 56 as shown in FIG. 1A. FIG. 8A depicts the position of the front dropouts 72 in relation to the front bracket 54. The quick release 130 is tightened to fix the front dropouts 72 into position. FIG. 9 depicts the position of the rear dropouts 74 in relation to the rear bracket 56. The quick release 130 is tightened to fix the rear dropouts 74 in position.

FIG. 15 shows how the bicycle wheels 64 are positioned in relation to the bicycle frame 62. The bicycle wheel elastic 194 laces through the bicycle wheel 64A, beneath the top tube 70, and through the other bicycle wheel 64B. The bicycle wheel elastic 194 is stretched over the top of the bicycle wheels 64 and is fixed to itself, holding them in position.

FIG. 16 shows the position of the handlebar 66 in relation to the bicycle frame 62. The handlebar 66 is removed from the bicycle frame 62, placed inside the handlebar bag 196 or the shipping storage bag 224, and positioned on the side of the bicycle frame 62. The compression straps 198 are wrapped around the bicycle frame 62 and buckled, fixing the handlebar bag 196 in position.

FIG. 17 shows one of the possible positions for storing the seat post 68. The seat post 68 can be transported in a variety of positions depending upon the situation. The seat post 68 is removed from the bicycle frame 62 and placed on the trailer bottom mesh 43. A seat post elastic 200 is fixed to the trailer bottom tube 37, laced around the seat post 68, and fixed to the opposite side of the trailer bottom tube 37, holding the seat in position.

FIG. 2 depicts the panel assemblies 34 in their folded down position. The seat post elastic 200 and the bicycle wheel elastic 194 are stretched around the panel assemblies 34 to fix them in their folded position when they are not functioning as a bicycle case. During the loading of the bicycle 61 into the bicycle case, the seat post elastic 200 and the bicycle wheel elastic 194 are removed from the panel assemblies 34 and used to secure the seat post 68 and the bicycle wheels 64.

The following is a description of how the panel assemblies are reconfigured from their folded down position as shown in FIG. 2 to their unfolded position as shown in FIG. 1B. The top front panels 80 and the bottom front panels 78 are swung forward simultaneously on the bottom spread hinges 110, the top spread hinges 112, and the vertical hinges 114. The top front panels 80 and the top rear panels 82 are then swung up on the horizontal hinges 106. When both panel assemblies 34 are in their open position, the top cover 76 is ready to be installed.

FIG. 1A shows the positions of all of the panel holes 49 for mounting the crossbar assemblies 39. The position of each of the crossbar assemblies 39 after the top cover 34 has been mounted is shown in FIG. 1B. The top cover 76 is mounted to the bicycle case by mounting the fixtures of the crossbar assemblies 39 and the other parts of the top cover 76 to the panel assemblies 34 and by mounting the tensioners to the front bracket 54, the rear bracket 56, and the bicycle frame 62. This can be done in a variety of orders. Following is a description of the preferred order of installation.

First, FIG. 5 shows a close-up view of the mounting operation of a crossbar assembly 39, which is the same for the installation of all of the crossbar assemblies 39. The crossbar assemblies 39 are mounted to the panel assemblies 34 by inserting the crossbar caps 36 through the panel holes 49 and through the adjacent grommets 52 on the top cover skirts 176. The linch pins 50 are then inserted through the ends of the crossbar caps 36, fixing them in position.

The crossbar assembly 39B is first mounted to the panel holes 49C and 49D. The crossbar assembly 39A is then mounted to the panel holes 49A and 49B. At this point, before the trailer fork caps 41 are mounted to the top cover 76, the front tensioner 46 (FIG. 12) is ready for installation. The male and female ends of the front tensioner buckle 180 are clipped together to install the front tensioner 46. The length of the front tensioner cords 178A and 178B are adjusted in relation to the positioning of the front bracket 54. This is accomplished by releasing the front tensioner cord lock 181 and adjusting the front tensioner cords 178A and 178B to the correct length. The trailer fork caps 41 are then mounted to the panel holes 49M and 49N. Mounting trailer fork caps 41 is nearly identical to mounting the crossbar caps 36 of the crossbar assemblies 39 as described above. The grommets 52 on the very front edge of the top cover skirt 176 are used for mounting to the trailer fork caps 41.

The forward most frame tensioner 44 (FIG. 14) is then mounted to the top tube 70 of the bicycle frame 62. The frame tensioner guide 189 is placed on the top tube 70. The frame tensioner loop 187 extends out of one side of the frame tensioner guide 189, wraps around the top tube 70, and then hooks to the other side of the frame tensioner guide 189. The frame tensioner loop 187 is tightened by pulling it though the frame tensioner loop lock 191. The length of the frame tensioner cords 188 are adjusted in relation to the positioning of the bicycle frame 62 within the bicycle case. This is accomplished by releasing the frame tensioner cord locks 190 and adjusting the frame tensioner cords 188 to the correct length.

The crossbar assembly 39C is then mounted to the panel holes 49E and 49F. The rearward frame tensioner 44 (FIG. 14) is then mounted to the top tube 70 in the same manner as the forward most frame tensioner 44. The crossbar assembly 39D is then mounted to the panel holes 49G and 49H. The crossbar assembly 39E is then mounted to the panel holes 491 and 49J. The crossbar assembly 39F is then mounted to the panel holes 49K and 49L. The rear tensioner 48 (FIG. 13) is then mounted to the rear bracket 56. This is accomplished by fitting the rear tensioner ring 184 over the rear bracket hook 186. The lengths of the rear tensioner cords 182 do not require adjustment.

The rear end of the top cover 76 (FIG. 1C) fits over the derailleur guard 58. To secure the rear end of the top cover 76, the cover hooks 100 are hooked to the panel rings 102 and the cover loops 101 are wrapped around the trailer 30. Finally, the male and female ends of the cover buckles 90 (FIG. 1B) are attached to join the support straps 96 to the center handle straps 86.

In the second view of the rear end of the top cover 76 (FIG. 1D), the trailer wheel 31 is removed and stored inside of the bicycle case and replace with the small wheel 222. The rear end of the top cover 76 is secured by installing the bottom most crossbar assemblies 39 into the panel holes 49.

The bicycle case is ready to transport the disassembled bicycle 61. The panel assemblies 34 provide protection from impacts to the right and left sides of the disassembled bicycle 61. The trailer 30 provides protection along the bottom of the disassembled bicycle 61. The top cover 76 brings the panel assemblies 34 together into a unified assembly and provides protection from impacts to the front, top and rear sides of the disassembled bicycle 61. The pads 171 are located in the top cover 76 to provide extra protection for the sections of the bicycle frame 62 that are located closest to the top cover 76. The derailleur guard 58 provides isolated, efficient protection for the asymmetrical position of the derailleur 146.

The top cover 76 fits snugly over the panel assemblies 34, creating a rigid, box-like structure. The front tensioner 46, the rear tensioner 48, and the frame tensioner 44 hold the top cover 76 and the panel assemblies 34 at a fixed distance from the front bracket 54, the rear bracket 56, and the bicycle frame 62. The panel assemblies 34 and the top cover 34 are thus prevented from coming into contact with the disassembled bicycle 61. The majority of the force of an impact to the bicycle case is absorbed by the top cover 76 and the panel assemblies 34. The disassembled bicycle 61 absorbs only the vibrations of the impact that are transferred through the trailer 30, the front bracket 54, the rear bracket 56, and the frame tensioners 44.

The bicycle case is easily maneuvered by holding the front handle 42 and pulling while walking forward. The bicycle case rolls on the caster assemblies 60 and the trailer wheel 31 or the small wheel 222. The casters 156 swivel 360 degrees, allowing the bicycle case to turn as it is pulled along. The bicycle case can be lifted up by grabbing the front handle 42 and the center handle 40. When lifting the bicycle case in this manner, the majority of its weight is centered on the center handle 40 through the center handle straps 86 and the support straps 96. When the bicycle case is placed into a luggage compartment, it can be set upright on the caster assemblies 60 and the trailer wheel 31. It can also be placed on its side, resting on one of the panel assemblies 34. It is sturdy enough that in either position, other packages can be stacked on top of it. When the bicycle case is placed in a luggage compartment, the trailer wheel 31 can be removed to shorten the overall length of the bicycle case.

When traveling with a disassembled bicycle 61 inside of the bicycle case, it is convenient to carry travel gear in a large backpack, leaving both hands free to deal with the bicycle case. When the bicycle 61 is reassembled for a bicycle tour and the trailer 30 is mounted to the bicycle 61 and reconfigured for transporting travel gear, the large backpack can be placed inside of the trailer 30. The rolled up top cover 34 in the handlebar bag 196 or the shipping/storage bag 224 and the removed front bracket 54 can be stored inside of the large backpack along with the travel gear.

During some bicycle tours it will be desired to remove the additional weight of the collapsible bicycle case from the trailer 30. In these instances the panel assemblies 34, the top cover 76, the rear bracket 56, the front bracket 54, and the caster assemblies 60 can all be removed from the trailer 30 and stored inside of the shipping storage bag 224. With the entire collapsible bicycle case arranged in this manner, the collapsible bicycle case can be easily stored or shipped ahead for use later in the bicycle tour.

Description—FIGS. 18-20—Additional Embodiment

An additional embodiment of the bicycle case of the present invention is shown in FIGS. 18, 19, and 20. FIG. 18 shows the bicycle case with an internal view of the disassembled bicycle 61 mounted to the collapsible frame 202. All of the parts of the disassembled bicycle 61 are visible. Only the major outlines of the panel assemblies 34 are visible, allowing for a less cluttered, internal view. The external view of the additional embodiment is nearly identical to that of the preferred embodiment pictured in FIG. 1B and should be considered as an equivalent depiction.

The additional embodiment utilizes the collapsible frame 202 rather than the trailer 30 as the central frame structure for mounting the components of the bicycle case. The collapsible frame 202 is proportioned so that the bicycle case can fit over it and mount to it in the same way that the bicycle case of the preferred embodiment fits over and mounts to the trailer 30.

FIG. 19 depicts the collapsible frame 202 in its open position without the panel assemblies 34 mounted to it. The collapsible frame 202 is comprised of a mounting body 208, swivel arms 212, panel supports 214, an extendable arm 216, and a seat post mount 218. The inside facing ends of the swivel arms 212 are attached through the swivel arm joints 210 to the mounting body 208. The outside facing ends of the swivel arms 212 are attached to the panel supports 214 through the panel support joints 211. The extendable arm 216 inserts and attaches to the mounting body 208.

The front bracket 54 is attached to the extendable arm 216. The rear bracket 56 is attached to the mounting body 208. The derailleur guard 58 is mounted to the rear bracket 56. The collapsible frame front casters 204 are attached to the front bracket 54. The collapsible frame panel mounts 220 are attached to the front bracket 54 and serve the same purpose as the trailer fork caps 41 of the preferred embodiment by mounting to the opened panel assemblies 34. The collapsible frame rear casters 206 are attached to the rearward panel support joints 211. The seat post mount 218 is attached to one of the two panel supports 214. The panel assemblies 34 can be attached to the panel supports 214.

Refer to the preferred embodiment description and operation sections for details on the front bracket 54, the rear bracket 56, the derailleur guard 58, the panel assemblies 34, and the top cover 76.

FIG. 20 depicts the additional embodiment with panel assemblies 34 in their folded position and the collapsible frame 202 in its collapsed position. The additional embodiment is shown mounted to the seat post 68 of the bicycle 61 by the seat post mount 218.

Operation—Additional Embodiment—FIGS. 18-20

The additional embodiment does not require assembly as does the preferred embodiment. The additional embodiment protects the disassembled bicycle 61 in the same way that the preferred embodiment does. The additional embodiment is also handled manually in the same way that the preferred embodiment is handled. The main difference that will be explained here is the way in which the disassembled bicycle 61 is loaded into the additional embodiment.

Opening the collapsible frame 202 from its closed position as depicted in FIG. 20 to its open position as depicted in FIG. 19 is the first step in loading the bicycle 61. This is accomplished by swinging the swivel arms 212 from a position that is parallel to the mounting body 208 to a position that is perpendicular to the mounting body 208. When the swivel arms 212 are swung open, the attached panel supports 214 are moved to a greater distance from the mounting body 208 while remaining parallel to it. The extendable arm 216 is extended out of the mounting body 208 to its full length.

FIG. 18 depicts the disassembled bicycle 61 loaded into the additional embodiment. The disassembled bicycle 61 is mounted onto the front bracket 54 and the rear bracket 56 in the same manner as is done in the preferred embodiment. The panel assemblies 34 and the top cover 76 are opened and assembled in the same manner as is done in the preferred embodiment.

FIG. 20 depicts the additional embodiment with the panel assemblies 34 folded up and the collapsible frame 202 in its collapsed position. The additional embodiment is shown mounted to the seat post 68 with the seat post mount 218. In this position, the bicycle 61 can be ridden while transporting the additional embodiment. The top cover 76 can be tied to the additional embodiment or easily carried in a backpack.

Conclusion, Ramifications, and Scope

Thus, the reader will see that the bicycle case of this invention is easy to assemble and disassemble, is lightweight and easily transported by a cyclist while riding a bicycle, and fully protects a bicycle from abusive cargo handling through the structure itself and with its mechanisms that suspend the bicycle in a centered position apart from its shock absorbing structure. In addition, the bicycle case is easy to manually transport by pulling it on its casters and lifting it by its handles, collapses to a small size to take up minimal storage space when not in use, and is adjustable for a full range of adult-sized bicycles. Furthermore, the preferred embodiment of the bicycle case utilizes a bicycle trailer in a way that allows for the cyclist to also enjoy the benefit of using the bicycle trailer when traveling. The components of the preferred embodiment of the bicycle case can be easily disassembled from the bicycle trailer when the benefit of their use is not desired. A further, additional embodiment of the bicycle case uses a collapsible bicycle case frame as its central frame structure. Once the additional embodiment has been folded up and collapsed, it can be mounted to the seat post of a bicycle and easily transported while riding the bicycle.

While my above description contains many specificities, these should not be construed as limitations on the scope of the invention but rather as an exemplification of one preferred embodiment thereof Many other embodiments are possible. For example, the bicycle trailer can be built with the components of the bicycle case integrated into it. The bicycle case can be adapted to function on a variety of bicycle trailers. This includes, but is not limited to, a variety of single-wheeled trailers, a variety of two-wheeled trailers, a variety of trailers utilizing a bicycle-to-trailer mount on the bicycle axle, a variety of trailers utilizing a trailer-to-bicycle mount on the seat post, a variety of trailers utilizing a trailer-to-bicycle mount on a bicycle luggage rack, and a variety of collapsible trailers.

The additional embodiment of the bicycle case of this invention is a collapsible bicycle case frame that provides the central frame structure and the mounting points for the components of the bicycle case. Many of the important elements of this bicycle case can be used in other embodiments of shipping cases. These shipping cases will also involve a central frame structure for mounting the panel assemblies. This central frame structure can either collapse in a manner similar to that of the collapsible bicycle case frame or it can be noncollapsible. These shipping cases will implement panel assemblies, casters, and a top cover similar to that of the preferred and additional embodiments, but it will not implement the bicycle mounting brackets which are specific to shipping a bicycle. Shipping cases that utilize the benefits of the bicycle case will themselves have the benefits of being easy to set up and collapse, of using up less storage space when not in use, of being easier to transport when not in use, and possibly of reconfiguring into a different useful item when not in use

Additional components can be integrated or included with the bicycle case to enhance its performance. For example a variety of pads can be inserted or integrated onto the insides of the panel assemblies and between or around the bicycle wheels and bicycle frame for added protection. Components for fixing the bicycle wheel, the seat post, and the handlebars can be included. Guards to protect the drive train assembly and the brakes can also be included. Fixtures such as pads and straps with hooks can be mounted to the bottom or the side of the bicycle case, allowing for it to mount onto the back or the top of a passenger vehicle.

Each of the components of the bicycle case of this invention can take on a variety of embodiments. This includes, but is not limited to, the components being eliminated or duplicated, the components being changed in size, the components being made of a different material, the components being made in a different shape, the components being connected or associated with its adjacent components in a different manner, the components being given a different mode of operation, and the components being made integrally or separately.

Listed below are all of the major components of the bicycle case of this invention. Each component is followed by a listing of some of its possible embodiments. This list is thorough to show the range of possible embodiments, but it does not include every possible embodiment. The possible embodiments shall not be limited to what is listed below but shall be determined by the appended claims and their legal equivalents.

It is intended that the embodiments of the component parts of the bicycle case listed below, are considered with reference to all of the possible embodiments of the bicycle cases listed above. The embodiments of these bicycle cases will be more simply referred to as the central frame structures in the following ramifications. In most of the embodiments of the bicycle case, the component parts are mounted to the central frame structure. In the other embodiments, the central frame structure is integrated into and part of the bicycle case components. The term central frame structure refers to all of the possible embodiments of the bicycle case including both the central frame structures integrated into the bicycle case components and the central frame structures not integrated into the bicycle case components.

The function of the panel assemblies is to protect the sides of the disassembled bicycle. A variety of flat, structural materials can be used to accomplish this purpose. These materials include, but are not limited to, a variety of each of the following: plastics, sheet metal, wood paneling, composites, and assemblies of wire forming the shape of a panel. The overall shape of the panels can take on a larger or smaller size. The shape of the panel assemblies can use different shapes to provide more room for configuring the disassembled bicycle in a different manner. The panel assemblies can be integrated into the sides of the central frame structures by permanent attachment or by using the panel assemblies as the sides themselves.

The function of the hinges on the panel assemblies is to allow the panels to fold up against each other. Because of these hinges, the panel assemblies can be folded and unfolded between the small compact position that is easy to transport while riding the bicycle and the large surfaces that protects the sides of the bicycle. A variety of hinges and hinging type structures can be used to accomplish this purpose. These hinges include, but are not limited to, a variety of metal hinges that move on pins, a variety of plastic hinges that move on pins, and a variety of plastic hinges that move on flexible plastic. The entire panel assembly can be a continuous plastic piece manufactured with a plastic injection mold that includes flexible plastic hinges in the design. Rather than unfolding, the panel assemblies can fan out around pivoting types hinges. The fanning panel assemblies can use a variety of pins, screws, sex-bolts, or other centrally pivoting hinges. These centrally pivoting hinges can be located in a variety of positions on the surface of the panels to allow for a variety of folded configurations and unfolded configurations. The panels can also move between the open and closed positions, by moving on a variety of slides and rollers. The panel assemblies can also fold down against each onto the bottom surface of the central frame structures. The panel assemblies can also pivot down into other possible configurations when not in use.

The function of the cinch cords is to mount the panel assemblies to the sides of the central frame structures. A variety of fixtures can be used to mount the panel assemblies. These include, but are not limited to, a variety of each of the following: clips, hose clamps, wires, cords, and hooks. The cinch cords can be eliminated if the panel assemblies were integrated into the central frame structures. The cinch cords can also be used in greater or lesser frequency in a variety of locations on the sides of the central frame structures.

The function of the trailer fork caps is to connect the panel assemblies to the bicycle trailer fork of the preferred embodiment when they are in their open position. A similarly constructed and positioned component on the other central frame structures will function in the same way. The term “panel mounting cap” refers to all of these embodiments. A variety of fixtures can be used for the panel mounting caps. These include, but are not limited to, a variety of each of the following: clamps, clips, ties, and screws. The panel mounting caps can be integrated into the central frame structure. The panel mounting caps can also be integrated into the top cover and be easily removable from the central frame structure.

The function of the top cover is to fill in the opening between the panel assemblies and to provide a central assembly that all of the components of the bicycle case can be drawn towards for creating structure throughout the bicycle case. The top cover can be constructed from a variety material. These include, but are not limited to, a variety of the following materials: pack cloth, canvas, other cloth, and plastic sheets. The top cover can be constructed in a variety of shapes. One example is a top cover that fits over the entire bicycle case. Other examples of possible changes will be adjustments to make the top cover convertible into a bag or ground cloth. The top cover can also be integrated into the panel assemblies of the central frame structure.

The function of the crossbar assemblies is to provide cross support members between the panel assemblies and mounting sections for the top cover. The crossbars can be constructed from a variety of structures. These include, but are not limited to, a variety of the following structures: tubes, rods, extrusions, and bars. The crossbars can be constructed from a variety of materials. These include, but are not limited to, a variety of the following materials: plastic, metal, wood, and composites. The crossbars assemblies can be attached to the top cover with a variety of fixtures. These include, but are not limited to, a variety of the following fixtures: straps, cords, and seams sewn into the top cover. The number and the placement of the crossbar assemblies along the panel assemblies can be increased or decreased.

The function of the crossbar caps is to provide a way to secure the crossbar assemblies, the panel assemblies and the edges of the top cover together. This can be an accomplished with a variety of fixtures. These include, but are not limited to, a variety of the following fixtures: hooks, levers, clips, clamps, pins, and screws. The crossbars can also be integrated into the panel assemblies.

The function of the handles of the top cover is to provide a place to hold while pulling the bicycle case and to provide a place to grab in order to pick up the bicycle case. The handles can be constructed from a variety of materials. These include, but are not limited to, a variety of the following: straps, handles, tubes, and cords. There can be more or less handles, and these handles can be placed in a variety of positions.

The function of the handlebar bag or the also used shipping/storage bag is to provide a means for securing the handlebar in place against the bicycle frame without damaging the bicycle frame. The handlebar bag or the shipping/storage bag when it is not in use for the first stated purpose also provides several alternative means for storing the components of the collapsible bicycle case. The handlebar bag and the handle bar bag can be constructed from a variety material. These include, but are not limited to, a variety of the following materials: pack cloth, canvas, other cloth, and plastic sheets. The handlebar bag and the shipping/storage bag can be constructed in a variety of shapes. The handle bar bag and the shipping bag can be designed to hold the components of the collapsible bicycle cases in a variety of ways.

The function of the support straps is to provide support beneath the entire weight of the bicycle case when it is lifted by the center handles. The support straps also provide a further means for securing the top cover against the panel assemblies and also add to the overall strength of the structure of the bicycle case. The support straps can be made from a variety of materials. These include, but are not limited to, a variety of the following materials: straps, cords, cloth and wire. The support straps can interface with the top cover and the panel assemblies in a variety of ways, and there can be more or less of them.

The function of the front bracket is to provide a means for mounting the front dropouts of the bicycle to the central frame structure. The front bracket can be made with a variety of materials. These include, but are not limited to, a variety of the following materials: plastic, metal, composites, and wood. The front bracket can be made in a variety of structural shapes. These include, but are not limited to, a variety of the following structural shapes: u-brackets, channel assemblies, rod assemblies, tubing assemblies, and wire assemblies. The front bracket can be mounted in a variety of ways to the front end of the central frame structure. The mounts can also be integrated into the central frame structure in a variety of ways. Entirely different clamping systems can be used for holding the front end of the bicycle in the bicycle case. For example, a tube clamp can hold the down tube of the bicycle or mount onto one or both of the fork legs.

The function of the rear bracket is to provide a means for mounting the rear dropouts of a bicycle to the central frame structure. The rear bracket can be made with a variety of materials. These include, but are not limited to, a variety of the following materials: plastic, metal, composites, and wood. The rear bracket can be made in a variety of structural shapes. These include, but are not be limited to, a variety of the following structural shapes: u-brackets, channel assemblies, rod assemblies, tubing assemblies, and wire assemblies. The rear bracket can be mounted to the central frame structure in a variety of ways. The rear bracket can be integrated into the central frame structure in a variety of ways. Other clamping systems can be used for mounting the rear end of the bicycle into the central frame structure. Other parts of the rear end of the bicycle frame can be clamped into position with a variety of fixtures

The function of the casters is to provide wheels for manually rolling the bicycle case. These casters swivel so that the bicycle case can be turned as it is pulled. A variety of casters, wheels, and caster mounting assemblies can be used on the bicycle case. Each of these can come in a variety of different shapes and sizes and can be mounted onto the central frame structure in a variety of ways.

The function of the derailleur guard is to provide extra protection for the rear derailleur of the bicycle. A variety of materials can be used for making the derailleur guard. These include, but are not limited to, a variety of the following: plastic, metals, composites, and wood. The derailleur guard can be made with a variety of protective structures. For example, a box or a wire frame can also be used. The derailleur guard can be mounted form a variety of places on the bicycle case including the rear bracket, the panel assemblies, and the central frame structure.

The function of the tensioner systems is to hold the disassembled bicycle at a protective distance from the shock absorbing panel assemblies and top cover. A variety of materials can be used for the tensioner cords. These include, but are not limited to, a variety of the following: cords, straps, and wires. The tensioners are attached to the central frame structure, the top tube of the bicycle, and the front and rear brackets. This can be accomplished with a variety of clips, clamps, straps, hooks, or other fixtures. The number and placement of the tensioners can also be changed. The tensioners can also be eliminated altogether without altering the basic function of the bicycle case.

The arrangement of the disassembled bicycle parts can be altered to accommodate changes in the overall design of the bicycle case. The wheels can be mounted in different positions against the bicycle frame. The seat post could be mounted in a large variety of areas in the bicycle case, especially with the implementation of a specific mounting device.

The collapsible bicycle case frame functions as the central frame structure for the bicycle case in the additional embodiment. The collapsible bicycle case frame can integrate all of the components of the bicycle case into itself The collapsible frame can fold up in a variety of ways with the swing arm joints and the panel support joints pivoting in a variety of directions. The component parts of the collapsible frame can be made in a variety of structural shapes and with a variety of materials and fixtures.

Accordingly, the scope of the invention shall not be determined by the embodiments illustrated but by the appended claims and their legal equivalents.

I claim:

1. A collapsible shipping container comprising:
(a) a base frame having opposite first and second sides each having a length and a height;
(b) a first side panel comprised of a plurality of sub-panels hingedly joined so said first side panel may be folded to a collapsed position or unfolded to a use position and secured to said side base extending substantially the length and height of the first side;
(c) a second side panel comprised of a plurality of sub-panels hingedly joined so said second side panel may be folded to a collapsed position or unfolded to a use position and secured to said base extending substantially the length and height of the second side; and
(d) a cover securable between said first and second side panels.

2. The collapsible shipping container as set forth in claim 1, further including a front bracket and a rear bracket with means for attaching to said base frame and with means for mounting a bicycle frame into a fixed position to said base.

3. The collapsible shipping container as set forth in claim 1, further including at least one tensioner comprising a flexible material attached to the edges of said first and second side panels with means for attachment to fixed points of said collapsible shipping container.

4. The collapsible shipping container as set forth in claim 1, further including at least one caster secured to said base frame.

5. The collapsible shipping container as set forth in claim 1, further including at least one crossbar attached to said top cover to secure said cover between said first and second side panels along their front, top, and rear edges.

6. The collapsible shipping container as set forth in claim 1, wherein said first side panel includes means for attachment to said first side of said base frame, said first side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

7. The collapsible shipping container as set forth in claim 1, wherein said second side panel includes means for attachment to said second side of said base frame, said second side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

8. The collapsible shipping container as set forth in claim 1, wherein said base frame is a bicycle trailer.

9. The collapsible shipping container as set forth in claim 8, wherein said bicycle trailer has a spoked wheel.

10. The collapsible shipping container as set forth in claim 9, wherein said spoked wheel is replaceable with a smaller non-spoked wheel.

11. The collapsible shipping container as set forth in claim 1, wherein said base frame is a collapsible frame, having a mounting body with an extendable arm, swing arms, and side walls defining the bottom and sides of said base frame, hinge means disposed in said extendable arms, swing arms and side walls to effect a substantially complete collapse of said base frame.

12. A collapsible shipping container for use with a bicycle trailer of the type having a frame with opposite first and second sides, a floor defining a compartment having a height and length, and a spoked wheel which can be replaced with a smaller non-spoked wheel during shipping, said container comprising:
(a) a first side panel comprised of a plurality of sub-panels hingedly joined so said first panel may be folded to a collapsed position or unfolded to a use position and secured extending substantially the length and height of the first side;
(b) a second side panel comprised of a plurality of sub-panels hingedly joined so said second panel may be folded to a collapsed position or unfolded to a use position and secured extending substantially the length and height of the second side; and
(c) a cover securable between said first and second side panels.

13. The collapsible shipping container as set forth in claim 12, further including a front bracket and a rear bracket with means for attaching to said base frame and with means for mounting a bicycle frame into a fixed position.

14. The collapsible shipping container as set forth in claim 12, further including a plurality of tensioners comprising a flexible material attached to the edges of said first and second side panels with means for attachment to fixed points of said collapsible shipping container.

15. The collapsible shipping container as set forth in claim 12, further including a plurality of casters secured to said base frame.

16. The collapsible shipping container as set forth in claim 12, further including at least one crossbar attached to said top cover to secure said cover between said first and second side panels along their front, top, and rear edges.

17. The collapsible shipping container as set forth in claim 12, wherein said first side panel includes means for attachment to said first side of said base frame, said first side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

18. The collapsible shipping container as set forth in claim 12, wherein said second side panel includes means for attachment to said second side of said base frame, said second side panel comprising a top front panel, a bottom front panel, a top-rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

19. A collapsible shipping container in combination with a bicycle trailer of the type having a frame with opposite first and second sides, a floor defining a compartment having a height and length, and a spoked wheel which can be replaced with a smaller non-spoked wheel during shipping, said container comprising:
(a) a first side panel comprised of a plurality of sub-panels hingedly joined so said first panel may be folded to a collapsed position or unfolded to a use position and secured extending substantially the length and height of the first side;
(b) a second side panel comprised of a plurality of sub-panels hingedly joined so said second panel may be folded to a collapsed position or unfolded to a use position and secured extending substantially the length and height of the second side; and
(c) a cover securable between said first and second side panels; whereby the bicycle can be disassembled and packed inside of the collapsible shipping container in combination with the bicycle trailer for shipping, and the bicycle can be reassembled and the collapsible shipping container in combination with the bicycle trailer can be connected to the rear end of the bicycle and used for carrying travel gear.

20. The collapsible shipping container as set forth in claim 19, further including a front bracket and a rear bracket with means for attaching to said base frame and means for mounting a bicycle frame into a fixed position to said brackets.

21. The collapsible shipping container as set forth in claim 19, further including a plurality of tensioners comprising of a flexible material attached to the edges of said first and second side panels with means for attaching to fixed points of said collapsible shipping container.

22. The collapsible shipping container as set forth in claim 19, further including a plurality of casters secured to said base frame.

23. The collapsible shipping container as set forth in claim 19, further including at least one crossbar attached to said top cover to secure said cover between said first and second side panels along their front, top, and rear edges.

24. The collapsible shipping container as set forth in claim 19, wherein said first side panel includes means for attachment to said first side of said base frame, said first side panel comprising of a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

25. The collapsible shipping container as set forth in claim 19, wherein said second side panel includes means for attaching to said second side of said base frame, said second side panel comprising of a top front panel, a bottom front panel, a top-rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other.

26. A collapsible shipping container for use with a bicycle trailer of the type having a frame with opposite first and second sides, a floor defining a compartment having a height and length, and a spoked wheel which can be replaced with a smaller non-spoked wheel during shipping, said container comprising:
(a) a first side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other so said first side panel may be folded to a collapsed position or unfolded to a use position and secured extending substantially the length and height of the first side;
(b) a second side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other so said second side panel may be folded to a collapsed position or unfolded to a use position and secured extending substantially the length and height of the second side;
(c) a cover securable between said first and second side panels;
(d) a front bracket and a rear bracket with means for attaching said brackets to said bicycle trailer and with means for mounting a bicycle frame in a fixed position to said brackets;
(e) at least one tensioner comprising of a flexible material attached to the edges of said first and second side panels with means for attaching to fixed points of said collapsible shipping container;
(f) at least one caster secured to said bicycle trailer; and
(g) at least one crossbar that is attached to said top cover for securing between said first and second side panels along their front, top, and rear edges.

27. A collapsible shipping container in combination with a bicycle trailer of the type having a frame with opposite first and second sides, a floor defining a compartment having a height and length, and a spoked wheel which can be replaced with a smaller non-spoked wheel, said container comprising:
(a) a first side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other so said first side panel may be folded to a collapsed position or unfolded to a use position and secured extending substantially the length and height of the first side;
(b) a second side panel comprising a top front panel, a bottom front panel, a top rear panel and a bottom rear panel, said top front panel and said bottom front panel being hingedly joined to each other, said bottom front panel and said bottom rear panel being hingedly joined to each other, said bottom rear panel and said top rear panel being hingedly joined to each other, and said top rear panel and said top front panel being hingedly joined to each other so said second side panel may be folded to a collapsed position or unfolded to a use position and secured extending substantially the length and height of the second side;
(c) a cover securable between said first and second side panels;
(d) a front bracket and a rear bracket with means for attaching said brackets to said bicycle trailer and with means for mounting a bicycle frame in a fixed position to said brackets;
(e) at least one tensioner comprising of a flexible material attached to the edges of said first and second side panels with means for attaching to fixed points of said collapsible shipping container;
(f) at least one caster secured to said bicycle trailer; and
(g) at least one crossbar that is attached to said cover for securing between said first and second side panels along their front, top, and rear edges; whereby the bicycle can be disassembled and packed inside of the collapsible shipping container in combination with the bicycle trailer for shipping, and the bicycle can be reassembled and the collapsible shipping container in combination with the bicycle trailer can be connected to the rear end of the bicycle and used for carrying travel gear.
